(19) United States
(12) Patent Application Publication
(10) Pub. No.: US 2025/0219473 A1
(43) Pub. Date: Jul. 3, 2025

(54) MAGNETIC CORE, ROTATING ELECTRICAL MACHINE, AND BRUSHLESS MOTOR

(71) Applicant: Murata Manufacturing Co., Ltd., Nagaokakyo-shi (JP)

(72) Inventors: Hisato AMANO, Nagaokakyo-shi (JP); Kazuyoshi ISHIZUKA, Nagaokakyo-shi (JP); Ryosuke YAMAMOTO, Nagaokakyo-shi (JP); Takuya NANSAKA, Nagaokakyo-shi (JP); Mitsutoshi NATSUMEDA, Nagaokakyo-shi (JP); Takashi MOCHIDA, Nagaokakyo-shi (JP); Takashi SAKURADA, Nagaokakyo-shi (JP)

(21) Appl. No.: 19/081,390

(22) Filed: Mar. 17, 2025

Related U.S. Application Data
(63) Continuation of application No. PCT/JP2023/042584, filed on Nov. 28, 2023.

(30) Foreign Application Priority Data
Dec. 5, 2022 (JP) 2022-194080

(51) Int. Cl. H02K 1/14; H02K 1/02

(52) U.S. Cl. CPC H02K 1/14; H02K 1/02

(57) ABSTRACT

A magnetic core for a rotating electrical machine, that includes: a core back portion; and a tooth portion including a tooth main-body portion extending from the core back portion in a first direction and a tooth distal-end portion at a distal end of the tooth main-body portion in the first direction, and a position of a geometric center of the tooth portion differs from a position of a geometric center of the core back portion in a second direction parallel to a rotation axis of the rotating electrical machine in a state in which the magnetic core is assembled in the rotating electrical machine.

### CROSS REFERENCE TO RELATED APPLICATIONS

The present application is a continuation of International application No. PCT/JP2023/042584, filed Nov. 28, 2023, which claims priority to Japanese Patent Application No. 2022-194080, filed Dec. 5, 2022, the entire contents of each of which are incorporated herein by reference.

### TECHNICAL FIELD

The present disclosure relates to a magnetic core for a rotating electrical machine, a rotating electrical machine including a magnetic core, and a brushless motor including a magnetic core.

### BACKGROUND ART

Examples of known inventions relating to conventional magnetic cores include the magnetic core disclosed in Patent Document 1. The magnetic core disclosed in Patent Document 1 includes teeth extending from the inner peripheral surface of a cylindrical yoke extending in the direction parallel to the rotation axis, in the directions opposite to the radial directions of the yoke or teeth extending from the outer peripheral surface of a cylindrical yoke extending in the direction parallel to the rotation axis, in the radial directions of the yoke. The rotation axis mentioned above refers to the rotation axis of the rotating electrical machine in the state in which the magnetic core is assembled in the rotating electrical machine. Each tooth includes a tooth main-body portion around which a coil is wound and a tooth distal-end portion protruding from the tooth main-body portion in the direction parallel to the rotation axis and in the circumferential direction of the yoke.

Patent Document 1: Japanese Unexamined Patent Application Publication No. 2017-060395

### SUMMARY OF THE DISCLOSURE

As for the magnetic core disclosed in Patent Document 1, there is a desire to generate a thrust force in the direction parallel to the rotation axis.

To respond to the desire, an object of the present disclosure is to provide a magnetic core that enables the generation of a thrust force in the direction parallel to the rotation axis, a rotating electrical machine, and a brushless motor.

A magnetic core according to an aspect of the present disclosure is a magnetic core for a rotating electrical machine, the magnetic core including: a core back portion; and a tooth portion including a tooth main-body portion extending from the core back portion in a first direction and a tooth distal-end portion at a distal end of the tooth main-body portion in the first direction, in which a position of a geometric center of the tooth portion differs from a position of a geometric center of the core back portion in a second direction parallel to a rotation axis of the rotating electrical machine in a state in which the magnetic core is assembled in the rotating electrical machine.

With the present disclosure, it is possible to provide a magnetic core that enables the generation of a thrust force in the direction parallel to the rotation axis, a rotating electrical machine, and a brushless motor.

### BRIEF DESCRIPTION OF THE DRAWINGS

FIG. 1 is a perspective view of a magnetic core 1.

FIG. 2 is a cross-sectional view of the magnetic core 1 viewed in a fourth direction DIR4.

FIG. 3 is a perspective view of an outer appearance of a brushless motor 100 in which the magnetic core 1 is used.

FIG. 4 is a schematic perspective view of a disassembled brushless motor 100 in which the magnetic core 1 is used.

FIG. 5 is a cross-sectional view of a magnetic core 6 according to a comparative example, viewed in a fourth direction DIR4.

FIG. 6 is a cross-sectional view in the fourth direction DIR4, showing an example of magnetic forces F1 and F2 generated between the magnetic core 6 according to the comparative example and a rotor member 22 when a rotor 20 is rotating.

FIG. 7 is a cross-sectional view in the fourth direction DIR4, showing an example of magnetic forces F1 and F2 generated between the magnetic core 1 and the rotor member 22 when the rotor 20 is rotating.

FIG. 8 is a cross-sectional view of a magnetic core 1a viewed in the fourth direction DIR4.

FIG. 9 is a perspective view of a magnetic core 1b.

FIG. 10 is a cross-sectional view of the magnetic core 1b viewed in the fourth direction DIR4.

FIG. 11 is a cross-sectional view of the magnetic core 1b and a busbar 40 viewed in the fourth direction DIR4.

FIG. 12 is a perspective view of a magnetic core 1c.

FIG. 13 is a cross-sectional view of the magnetic core 1c viewed in the fourth direction DIR4.

### DESCRIPTION OF THE PREFERRED EMBODIMENTS

### First Embodiment

### Configuration of Magnetic Core 1

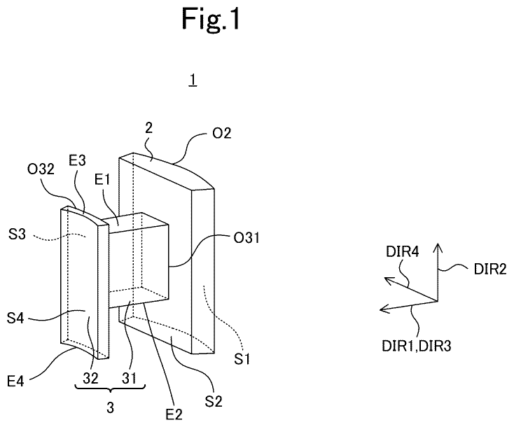

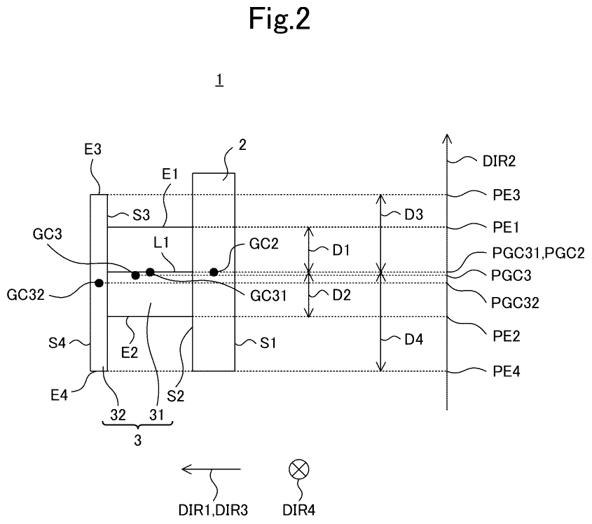

Hereinafter, the configuration of a magnetic core 1 according to a first embodiment of the present disclosure will be described with reference to drawings. FIG. 1 is a perspective view of the magnetic core 1. FIG. 2 is a cross-sectional view of the magnetic core 1 viewed in the fourth direction DIR4.

In this specification, directions are defined as follows: The direction in which a tooth main-body portion 31 extends is defined as the first direction DIR1. In the state in which the magnetic core 1 is assembled in a brushless motor 100, the direction parallel to the rotation axis of the brushless motor 100 is defined as the second direction DIR2. The orthogonal projection of the first direction DIR1 onto a plane orthogonal to the second direction DIR2 is defined as the third direction DIR3. In the present embodiment, the third direction DIR3 is the same as the first direction DIR1. The direction orthogonal to the second direction DIR2 and the third direction DIR3 is defined as the fourth direction DIR4. Since the third direction DIR3 is the same as the first direction DIR1 in the present embodiment, the fourth direction DIR4 is also orthogonal to the first direction DIR1. The first direction DIR1, the second direction DIR2, the third direction DIR3, and the fourth direction DIR4 are directions defined for explanation. Hence, the first direction DIR1, the second direction DIR2, the third direction DIR3, and the fourth direction DIR4 at the time of actual use of the magnetic core 1 do not necessarily need to correspond to the first direction DIR1, the second direction DIR2, the third direction DIR3, and the fourth direction DIR4 in the present embodiment.

The magnetic core 1 is used in the brushless motor 100. The brushless motor 100 is an example of a “rotating electrical machine” of the present disclosure.

As illustrated in FIG. 1, the magnetic core 1 includes a core back portion 2 and a tooth portion 3. The magnetic core 1 is composed of a soft magnetic material. A soft magnetic material is magnetized when an external magnetic field is applied to it. After that when the application of the magnetic field is stopped, the soft magnetic material loses the magnetization. Examples of such soft magnetic materials include iron.

The magnetic core 1 is a molded body formed of soft magnetic powder. Specifically, each of the core back portion 2 and the tooth portion 3 is a molded body formed of soft magnetic powder. The material of the soft magnetic powder contains, for example, iron and a binder. The binder is, for example, a resin. The soft magnetic powder is, for example, a mixture of iron powder and epoxy resin which is an example of a binder. The magnetic core 1 described above is produced by, for example, press molding. The outer surface of the magnetic core 1 is subjected to an insulation treatment.

As illustrated in FIGS. 1 and 2, the core back portion 2 has a first main surface S1 and a second main surface S2 aligned in the third direction DIR3. The second main surface S2 is positioned in the third direction DIR3 relative to the first main surface S1. As illustrated in FIG. 1, each of the first main surface S1 and the second main surface S2 has a rectangular shape when viewed in the third direction DIR3. As illustrated in FIG. 2, the core back portion 2 has a geometric center GC2. The geometric center GC2 is the position calculated as the arithmetic mean of all the points belonging to the core back portion 2. The core back portion 2 has a plane-symmetric shape with respect to a plane orthogonal to the second direction DIR2.

As illustrated in FIG. 1, the tooth portion 3 includes the tooth main-body portion 31 and a tooth distal-end portion 32. As illustrated in FIG. 2, the tooth portion 3 has a geometric center GC3. The geometric center GC3 is the position calculated as the arithmetic mean of all the points belonging to the tooth portion 3. The tooth main-body portion 31 extends from the core back portion 2 in the first direction DIR1. More specifically, the tooth main-body portion 31 extends from the second main surface S2 in the first direction DIR1. In the present embodiment, the first direction DIR1 is orthogonal to the second direction DIR2. Hence, the third direction DIR3 is the same as the first direction DIR1. The tooth main-body portion 31 has a rectangular parallelepiped shape. The tooth main-body portion 31 has a geometric center GC31. The geometric center GC31 is the position calculated as the arithmetic mean of all the points belonging to the tooth main-body portion 31. The tooth main-body portion 31 has a plane-symmetric shape with respect to a plane orthogonal to the second direction DIR2.

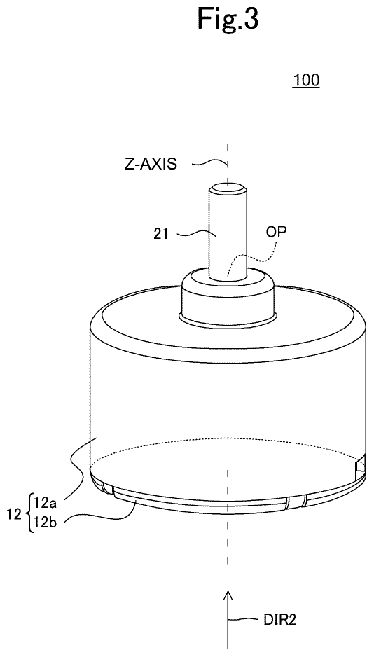

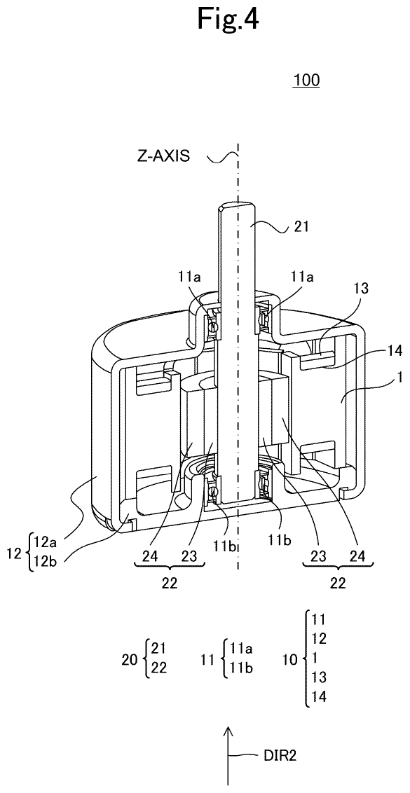

As illustrated in FIG. 1, the tooth main-body portion 31 has a first end E1 and a second end E2 which are the two ends in the second direction DIR2. The first end E1 is positioned in the second direction DIR2 relative to the second end E2. As illustrated in FIGS. 3 and 4, in the state in which the magnetic core 1 is assembled in the brushless motor 100, the second direction DIR2 is the direction parallel to the rotation axis of the brushless motor 100.

As illustrated in FIGS. 1 and 2, the tooth distal-end portion 32 has a third main surface S3 and a fourth main surface S4 aligned in the third direction DIR3. The fourth main surface S4 is positioned in the third direction DIR3 relative to the third main surface S3. Each of the third main surface S3 and the fourth main surface S4 has a rectangular shape when viewed in the third direction DIR3 as illustrated in FIG. 1. As illustrated in FIG. 2, the tooth distal-end portion 32 has a geometric center GC32. The geometric center GC32 is the position calculated as the arithmetic mean of all the points belonging to the tooth distal-end portion 32. The tooth distal-end portion 32 has a plane-symmetric shape with respect to a plane orthogonal to the second direction DIR2.

As illustrated in FIG. 1, the tooth distal-end portion 32 has a third end E3 and a fourth end E4 which are the two ends in the second direction DIR2. The third end E3 is positioned in the second direction DIR2 relative to the fourth end E4. As illustrated in FIG. 1, the tooth distal-end portion 32 as described above is located at the distal end of the tooth main-body portion 31 in the first direction DIR1.

As illustrated in FIG. 1, the outer edge O2 of the core back portion 2 viewed in the third direction DIR3 surrounds the outer edge O31 of the tooth main-body portion 31 viewed in the third direction DIR3. The outer edge O32 of the tooth distal-end portion 32 viewed in the third direction DIR3 surrounds the outer edge O31 of the tooth main-body portion 31 viewed in the third direction DIR3. As illustrated in FIG. 2, the tooth main-body portion 31 has a uniform length in the second direction DIR2 across the third direction DIR3.

In the present embodiment, as illustrated in FIG. 2, the distance D1 in the second direction DIR2 between the first end E1 of the tooth main-body portion 31 and the geometric center GC2 of the core back portion 2 is equal to the distance D2 in the second direction DIR2 between the second end E2 of the tooth main-body portion 31 and the geometric center GC2 of the core back portion 2. Hence, the position PGC31 of the geometric center GC31 of the tooth main-body portion 31 in the second direction DIR2 is the same as the position PGC2 of the geometric center GC2 of the core back portion 2 in the second direction DIR2.

However, as illustrated in FIG. 2, the distance D3 in the second direction DIR2 between the third end E3 of the tooth distal-end portion 32 and the geometric center GC2 of the core back portion 2 is smaller than the distance D4 in the second direction DIR2 between the fourth end E4 of the tooth distal-end portion 32 and the geometric center GC2 of the core back portion 2. Hence, the geometric center GC2 of the core back portion 2 is positioned in the second direction DIR2 relative to the geometric center GC32 of the tooth distal-end portion 32. In other words, the position PGC32 of the geometric center GC32 of the tooth distal-end portion 32 in the second direction DIR2 differs from the position PGC2 of the geometric center GC2 of the core back portion 2 in the second direction DIR2. Hence, the geometric center GC2 of the core back portion 2 is positioned in the second direction DIR2 relative to the geometric center GC3 of the tooth portion 3. In other words, in the second direction DIR2, the position PGC3 of the geometric center GC3 of the tooth portion 3 differs from the position PGC2 of the geometric center GC2 of the core back portion 2. More specifically, the geometric center GC2 of the core back portion 2 is positioned in the second direction DIR2 relative to the geometric center GC3 of the tooth portion 3. Hence, the magnetic core 1 does not have a plane-symmetric shape with respect to a plane orthogonal to the second direction DIR2. Note that the magnetic core 1 has a plane-symmetric shape with respect to a plane orthogonal to the fourth direction DIR4.

Here, the line connecting the geometric centers of the cross sections of the tooth main-body portion 31 perpendicular to the third direction DIR3 is defined as the first line L1. The geometric center of a cross section of the tooth main-body portion 31 perpendicular to the third direction DIR3 is the position calculated as the arithmetic mean of all the points belonging to the cross section of the tooth main-body portion 31 perpendicular to the third direction DIR3. In the present embodiment, the first line L1 is a straight line as illustrated in FIG. 2. In the present embodiment, the direction in which the first line L1 extends is parallel to the third direction DIR3 and orthogonal to the second direction DIR2. Specifically, in the second direction DIR2, the position of the first line L1 at the distal end of the tooth main-body portion 31 in the first direction DIR1 is the same as the position of the first line L1 at the opposite end of the tooth main-body portion 31 from the distal end.

### Configuration of Brushless Motor 100

Hereinafter, the configuration of the brushless motor 100 according to the first embodiment of the present disclosure will be described with reference to drawings. FIG. 3 is a perspective view of an outer appearance of the brushless motor 100 in which the magnetic core 1 is used. FIG. 4 is a schematic perspective view of a disassembled brushless motor 100 in which the magnetic core 1 is used. In FIG. 4, out of a plurality of magnetic cores 1, a plurality of coils 13, and a plurality of insulating members 14, only one representative of each is denoted by a reference symbol.

As illustrated in FIG. 4, the brushless motor 100 includes a rotor 20 and a stator assembly 10. As illustrated in FIG. 4, the stator assembly 10 is located around the rotor 20 when viewed in the second direction DIR2. In other words, the brushless motor 100 is an inner rotor motor.

As illustrated in FIG. 4, the rotor 20 includes a shaft 21 and a rotor member 22. The shaft 21 has a shape extending in the second direction DIR2. More specifically, the shaft 21 has a columnar shape. The rotor member 22 has a cylindrical shape. The center axis of each of the shaft 21 and the rotor member 22 corresponds to the Z-axis. In other words, the rotation axis of the brushless motor 100 corresponds to the Z-axis. Hence, the second direction DIR2 is parallel to the Z-axis.

As illustrated in FIG. 4, the rotor member 22 includes a soft magnetic material 23 and a hard magnetic material 24. The rotor member 22 is attached to the outer peripheral surface of the shaft 21 in the radial directions centered on the Z-axis. More specifically, the soft magnetic material 23 is attached to the outer peripheral surface of the shaft 21 in the radial directions centered on the Z-axis. The hard magnetic material 24 is attached to the outer peripheral surface of the soft magnetic material 23 in the radial directions centered on the Z-axis. The rotor member 22 is located such that the position PGC22 of the geometric center GC22 of the rotor member 22 in the second direction DIR2 is the same as the position PGC2 of the geometric center GC2 of the core back portion 2 in the second direction DIR2. Note that the geometric center GC22 is the position calculated as the arithmetic mean of all the points belonging to the rotor member 22.

The soft magnetic material 23 is composed of a soft magnetic material. The hard magnetic material 24 is composed of a hard magnetic material. A hard magnetic material is magnetized when an external magnetic field is applied. After that, even after the application of the magnetic field is stopped, the hard magnetic material does not lose the magnetization. Examples of such hard magnetic materials include a magnet.

As illustrated in FIG. 4, the stator assembly 10 includes bearings 11, a housing 12, the plurality of magnetic cores 1, the plurality of coils 13, and the plurality of insulating members 14. Hence, the brushless motor 100 includes the magnetic core 1.

The bearings 11 support the shaft 21 so that the shaft 21 can rotate in the circumferential direction centered on the Z-axis. More specifically, the bearings 11 are composed of a first bearing 11a and a second bearing 11b as illustrated in FIG. 4. Each of the first bearing 11a and the second bearing 11b is, for example, a ball bearing. The first bearing 11a and the second bearing 11b each have a cylindrical shape. The center axis of each of the first bearing 11a and the second bearing 11b corresponds to the Z-axis. In other words, the center axis of each of the first bearing 11a and the second bearing 11b coincides with the center axis of the shaft 21.

As illustrated in FIG. 4, the first bearing 11a is positioned in the second direction DIR2 relative to the second bearing 11b. The first bearing 11a is positioned in the second direction DIR2 relative to the rotor member 22. The second bearing 11b is positioned in the opposite direction to the second direction DIR2 relative to the rotor member 22. The second bearing 11b supports the end of the shaft 21 in the opposite direction to the second direction DIR2.

As illustrated in FIG. 3, the housing 12 includes a first housing 12a and a second housing 12b. As illustrated in FIGS. 3 and 4, the first housing 12a has a cylindrical shape. The center axis of the first housing 12a corresponds to the Z-axis. The first housing 12a is positioned in the second direction DIR2 relative to the second housing 12b. The first housing 12a has an opening OP. With this configuration, the end of the shaft 21 in the second direction DIR2 protrudes through the opening OP in the second direction DIR2. In other words, the brushless motor 100 is a single-shaft motor.

The first housing 12a supports the first bearing 11a, the plurality of magnetic cores 1, the plurality of coils 13, and the plurality of insulating members 14. The second housing 12b supports the second bearing 11b. Each of the first housing 12a and the second housing 12b is composed of, for example, a material having high stiffness such as stainless steel.

The plurality of magnetic cores 1, the plurality of coils 13, and the plurality of insulating members 14 each number nine. Each of the nine coils 13 and each of the nine insulating members 14 are located so as to be associated with the corresponding one of the nine magnetic cores 1. More specifically, when a combination of one magnetic core 1, one coil 13, and one insulating member 14 is considered to be one set, the nine sets are aligned in the circumferential direction centered on the Z-axis. Each set is arranged at a distance from the hard magnetic material 24 so as to encircle it. Note that each set has the same structure. Hence, a description will be given of one set including one magnetic core 1, one coil 13, and one insulating member 14.

The magnetic core 1 is magnetized by each of the magnetic field generated by the hard magnetic material 24 and the magnetic field generated by the coil 13. Thus, the magnetic core 1 generates a magnetic force that rotates the rotor. Note that an air gap is present between the magnetic core 1 and the rotor member 22 as illustrated in FIG. 4. In the present embodiment, in the state in which the magnetic core 1 is assembled in the brushless motor 100, the first direction DIR1 is a direction toward the rotation axis of the brushless motor 100.

As illustrated in FIG. 4, the coil 13 is wound around the tooth main-body portion 31 to be positioned around the magnetic core 1 when viewed in the radial direction centered on the Z-axis. The coil 13 is made of, for example, a conductive material such as copper. The coil 13 has a structure in which the surface of a copper wire is covered with an insulating film. When a current flows in the coil 13, the coil 13 generates a magnetic field.

The insulating member 14 is composed of an insulating material. As illustrated in FIG. 4, the insulating member 14 is located between the magnetic core 1 and the coil 13. Hence, the magnetic core 1 and the coil 13 are electrically insulated from each other. The insulating member 14 in the present embodiment is in a film form, but it may be in a plate form. Alternatively, the insulating member 14 may be provided such that part of the insulating member 14 is located between the magnetic core 1 and the coil 13. Hence, the insulating member 14 may be located on the entire surface of the coil 13.

The coil 13 is supplied with current from a power supply (not illustrated). The rotation of the rotor 20 is controlled by controlling this current.

### Advantageous Effects

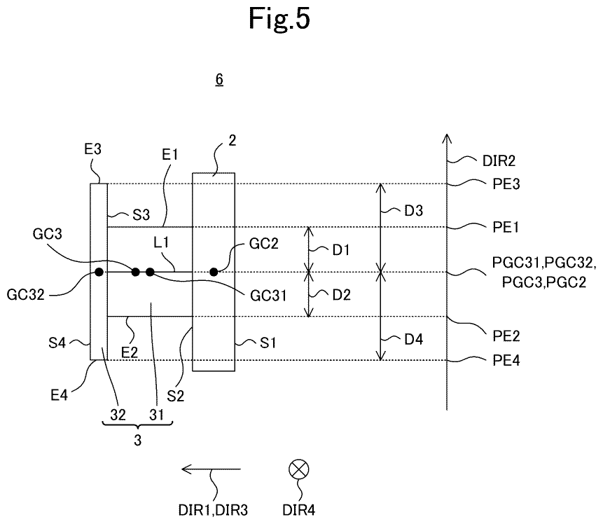

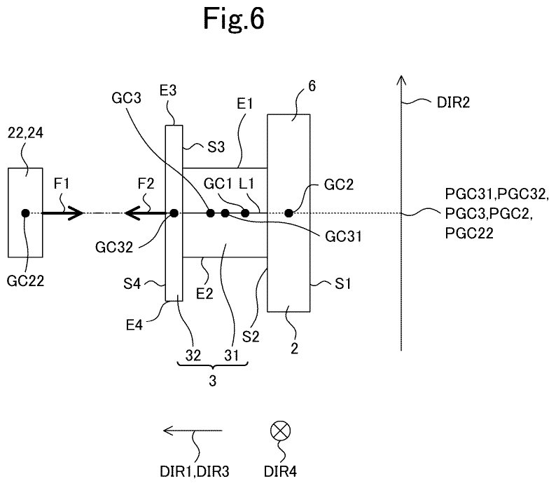

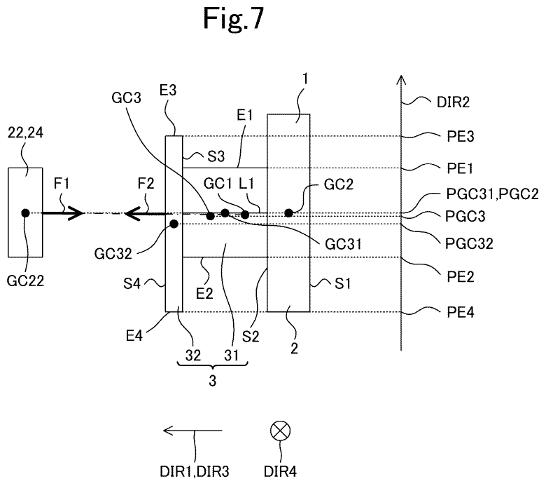

The magnetic core 1 enables the generation of a thrust force in the direction parallel to the rotation axis. A description will be given of the principle of how the thrust force can be generated in the direction parallel to the rotation axis with reference to drawings. FIG. 5 is a cross-sectional view of a magnetic core 6 according to a comparative example, viewed in the fourth direction DIR4. FIG. 6 is a cross-sectional view in the fourth direction DIR4, showing an example of magnetic forces F1 and F2 generated between the magnetic core 6 according to the comparative example and the rotor member 22 when the rotor 20 is rotating. FIG. 7 is a cross-sectional view in the fourth direction DIR4, showing an example of magnetic forces F1 and F2 generated between the magnetic core 1 and the rotor member 22 when the rotor 20 is rotating.

First, the magnetic core 6 according to the comparative example will be described. As for the magnetic core 6 according to the comparative example, only the portions different from those of the magnetic core 1 will be described, and description of the other portions will be omitted. In the magnetic core 6 according to the comparative example, as illustrated in FIG. 5, the distance D3 in the second direction DIR2 between the third end E3 of the tooth distal-end portion 32 and the geometric center GC2 of the core back portion 2 is equal to the distance D4 in the second direction DIR2 between the fourth end E4 of the tooth distal-end portion 32 and the geometric center GC2 of the core back portion 2. Hence, the position PGC32 of the geometric center GC32 of the tooth distal-end portion 32 in the second direction DIR2 is the same as the position PGC2 of the geometric center GC2 of the core back portion 2 in the second direction DIR2. Since each of the position PGC31 of the geometric center GC31 of the tooth main-body portion 31 in the second direction DIR2 and the position PGC32 of the geometric center GC32 of the tooth distal-end portion 32 in the second direction DIR2 is the same as the position PGC2 of the geometric center GC2 of the core back portion 2 in the second direction DIR2, the position PGC3 of the geometric center GC3 of the tooth portion 3 in the second direction DIR2 is the same as the position PGC2 of the geometric center GC2 of the core back portion 2 in the second direction DIR2. Hence, the position PGC6 of the geometric center GC6 of the magnetic core 6 according to the comparative example in the second direction DIR2 is the same as the position PGC2 of the geometric center GC2 of the core back portion 2 in the second direction DIR2. The magnetic core 6 according to the comparative example has a plane-symmetric shape with respect to a plane orthogonal to the second direction DIR2.

When the rotor 20 is rotating, the magnetic forces F1 and F2 are generated between the magnetic core 6 according to the comparative example and the rotor member 22 as illustrated in FIG. 6. The magnetic forces F1 and F2 are Coulomb forces acting between two magnetic charges. When the magnetic pole of the magnetic core 6 according to the comparative example and the magnetic pole of the surface of the rotor member 22 facing the opposite direction to the third direction DIR3 differ from each other, the direction of the magnetic force F1 is the third direction DIR3. In contrast, when the magnetic pole of the magnetic core 6 according to the comparative example and the magnetic pole of the surface of the rotor member 22 facing the opposite direction to the third direction DIR3 are the same as each other, the direction of the magnetic force F1 is the opposite direction to the third direction DIR3. In either case, the direction of the magnetic force F1 is parallel to the third direction DIR3. In other words, the direction of the magnetic force F1 is orthogonal to the second direction DIR2. Hence, the magnetic core 6 according to the comparative example generates no thrust force in the direction parallel to the rotation axis.

As for the magnetic core 1, in the second direction DIR2, the position PGC3 of the geometric center GC3 of the tooth portion 3 differs from the position PGC2 of the geometric center GC2 of the core back portion 2. Hence, the position PGC22 of the geometric center GC22 of the rotor member 22 in the second direction DIR2 differs from the position PGC1 of the geometric center GC1 of the magnetic core 1 in the second direction DIR2. Hence, each of the direction of the magnetic force F1 and the direction of the magnetic force F2 is not parallel to the third direction DIR3. More specifically, as illustrated in FIG. 7, the direction of the magnetic force F1 is parallel to the straight line connecting the geometric center GC22 of the rotor member 22 and the geometric center GC1 of the magnetic core 1. In the present embodiment, the geometric center GC22 of the rotor member 22 is positioned in the second direction DIR2 relative to the geometric center GC1 of the magnetic core 1. Hence, when the magnetic pole of the magnetic core 1 and the magnetic pole of the surface of the rotor member 22 facing the opposite direction to the third direction DIR3 differ from each other, the magnetic force F1 includes a component in the second direction DIR2. In contrast, when the magnetic pole of the magnetic core 1 and the magnetic pole of the surface of the rotor member 22 facing the opposite direction to the third direction DIR3 are the same as each other, the magnetic force F1 includes a component in the opposite direction to the second direction DIR2. In either case, the magnetic force F1 includes a component in the direction parallel to the rotation axis (the second direction DIR2 or the opposite direction to the second direction DIR2). Thus, the magnetic core 1 enables the generation of a thrust force in the direction parallel to the rotation axis.

The magnetic core 1 increases the thrust force in the direction parallel to the rotation axis. More specifically, the Coulomb force is inversely proportional to the square of the distance between two magnetic charges. Each of the magnetic force F1 and the magnetic force F2 is the composition of the Coulomb force acting between the rotor member 22 and the tooth distal-end portion 32, the Coulomb force acting between the rotor member 22 and the tooth main-body portion 31, and the Coulomb force acting between the rotor member 22 and the core back portion 2. In the state in which the magnetic core 1 is assembled in the brushless motor 100, the tooth distal-end portion 32 is located closest to the rotor member 22 out of the core back portion 2, the tooth main-body portion 31, and the tooth distal-end portion 32. In the magnetic core 1, the position PGC32 of the geometric center GC32 of the tooth distal-end portion 32 in the second direction DIR2 is located to be different from the position PGC2 of the geometric center GC2 of the core back portion 2 in the second direction DIR2. This configuration of the magnetic core 1 increases the thrust force in the direction parallel to the rotation axis.

In the magnetic core 1, it is possible to reserve a region that overlaps the tooth distal-end portion 32 when viewed in the second direction DIR2 and that is positioned in the second direction DIR2 relative to the tooth distal-end portion 32. More specifically, the distance D3 in the second direction DIR2 between the third end E3 of the tooth distal-end portion 32 and the geometric center GC2 of the core back portion 2 is smaller than the distance D4 in the second direction DIR2 between the fourth end E4 of the tooth distal-end portion 32 and the geometric center GC2 of the core back portion 2. Hence, the region that overlaps the tooth distal-end portion 32 when viewed in the second direction DIR2 and that is positioned in the second direction DIR2 relative to the tooth distal-end portion 32 can be larger than the region that overlaps the tooth distal-end portion 32 when viewed in the second direction DIR2 and that is positioned in the opposite direction to the second direction DIR2 relative to the tooth distal-end portion 32. Hence, in the magnetic core 1, it is possible to reserve a region that overlaps the tooth distal-end portion 32 when viewed in the second direction DIR2 and that is positioned in the second direction DIR2 relative the tooth distal-end portion 32.

The magnetic core 1 makes it easy to wind the coil 13 around the tooth main-body portion 31. More specifically, in the second direction DIR2, the position of the first line L1 at the distal end of the tooth main-body portion 31 in the first direction DIR2 is the same as the position of the first line L1 at the opposite end of the tooth main-body portion 31 from the distal end. In other words, the direction in which the first line L1 extends is orthogonal to the second direction DIR2 which is parallel to the rotation axis of the brushless motor 100. Hence, it is easy to wind the coil 13 around the tooth main-body portion 31 in the magnetic core 1.

The configuration of the magnetic core 1 makes it easy to form the magnetic core 1. More specifically, each of the core back portion 2, the tooth main-body portion 31, and the tooth distal-end portion 32 has a plane-symmetric shape with respect to a plane orthogonal to the second direction DIR2. Hence, for example, when the magnetic core 1 is produced by press molding, the magnetic core 1 can be produced by using a die and a punch having plane-symmetric shapes with respect to a plane orthogonal to the second direction DIR2. Thus, the configuration of the magnetic core 1 makes it easy to form the magnetic core 1.

### Second Embodiment

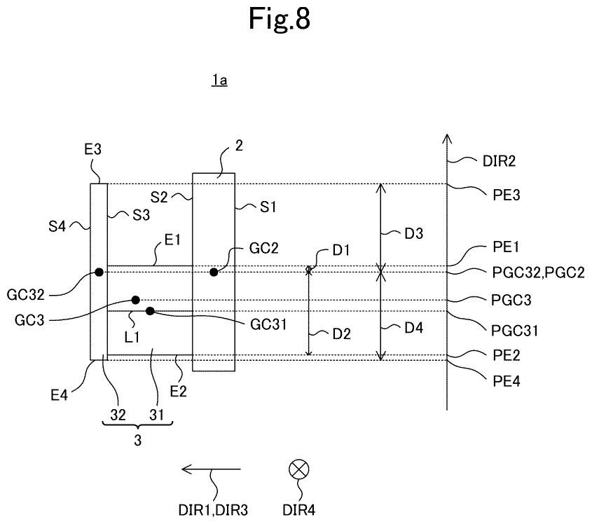

Hereinafter, a magnetic core 1a according to a second embodiment of the present disclosure will be described with reference to figures. FIG. 8 is a cross-sectional view of the magnetic core 1a viewed in the fourth direction DIR4. As for the magnetic core 1a according to the second embodiment, only the portions different from those of the magnetic core 1 according to the first embodiment will be described, and description of the other portions will be omitted.

As illustrated in FIG. 8, the magnetic core la differs from the magnetic core 1 in that the position PGC32 of the geometric center GC32 of the tooth distal-end portion 32 in the second direction DIR2 is the same as the position PGC2 of the geometric center GC2 of the core back portion 2 in the second direction DIR2, and in that the position PGC31 of the geometric center GC31 of the tooth main-body portion 31 in the second direction DIR2 differs from the position PGC2 of the geometric center GC2 of the core back portion 2 in the second direction DIR2.

More specifically, in the present embodiment, as illustrated in FIG. 8, the distance D3 in the second direction DIR2 between the third end E3 of the tooth distal-end portion 32 and the geometric center GC2 of the core back portion 2 is equal to the distance D4 in the second direction DIR2 between the fourth end E4 of the tooth distal-end portion 32 and the geometric center GC2 of the core back portion 2. Hence, the position PGC32 of the geometric center GC32 of the tooth distal-end portion 32 in the second direction DIR2 is the same as the position PGC2 of the geometric center GC2 of the core back portion 2 in the second direction DIR2.

However, as illustrated in FIG. 8, the distance D1 in the second direction DIR2 between the first end E1 of the tooth main-body portion 31 and the geometric center GC2 of the core back portion 2 is smaller than the distance D2 in the second direction DIR2 between the second end E2 of the tooth main-body portion 31 and the geometric center GC2 of the core back portion 2. Hence, the geometric center GC2 of the core back portion 2 is positioned in the second direction DIR2 relative to the geometric center GC31 of the tooth main-body portion 31. Hence, the geometric center GC2 of the core back portion 2 is positioned in the second direction DIR2 relative to the geometric center GC3 of the tooth portion 3. In other words, in the second direction DIR2, the position PGC3 of the geometric center GC3 of the tooth portion 3 differs from the position PGC2 of the geometric center GC2 of the core back portion 2.

The magnetic core 1a described above also provides the same advantageous effects as the magnetic core 1. In addition, in the magnetic core 1a, it is possible to reserve a region that overlaps the tooth main-body portion 31 when viewed in the second direction DIR2 and that is positioned in the second direction DIR2 relative to the tooth main-body portion 31. More specifically, the distance D1 in the second direction DIR2 between the first end E1 of the tooth main-body portion 31 and the geometric center GC2 of the core back portion 2 is smaller than the distance D2 in the second direction DIR2 between the second end E2 of the tooth main-body portion 31 and the geometric center GC2 of the core back portion 2. Hence, the region that overlaps the tooth main-body portion 31 when viewed in the second direction DIR2 and that is positioned in the second direction DIR2 relative to the tooth main-body portion 31 can be larger than the region that overlaps the tooth main-body portion 31 when viewed in the second direction DIR2 and that is positioned in the opposite direction to the second direction DIR2 relative to the tooth main-body portion 31. Hence, in the magnetic core 1a, it is possible to reserve a region that overlaps the tooth main-body portion 31 when viewed in the second direction DIR2 and that is positioned in the second direction DIR2 relative to the tooth main-body portion 31.

### Third Embodiment

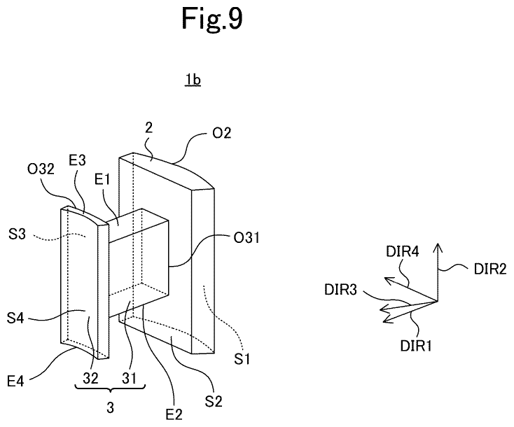

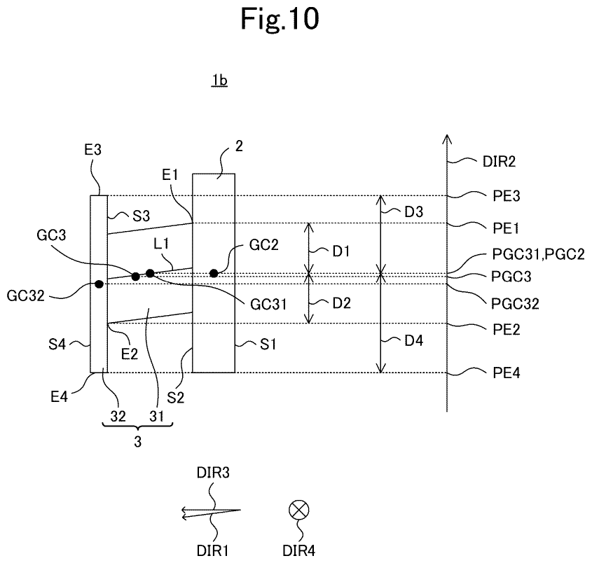

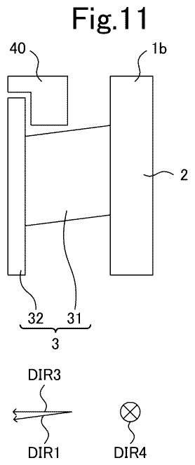

Hereinafter, a magnetic core 1b according to a third embodiment of the present disclosure will be described with reference to figures. FIG. 9 is a perspective view of the magnetic core 1b. FIG. 10 is a cross-sectional view of the magnetic core 1b viewed in the fourth direction DIR4. FIG. 11 is a cross-sectional view of the magnetic core 1b and a busbar 40 viewed in the fourth direction DIR4. As for the magnetic core 1b according to the third embodiment, only the portions different from those of the magnetic core 1 according to the first embodiment will be described, and description of the other portions will be omitted.

As illustrated in FIGS. 9 and 10, the magnetic core 1b differs from the magnetic core 1 in that the first direction DIR1 is not orthogonal to the second direction DIR2. In other words, in the present embodiment, the third direction DIR3 differs from the first direction DIR1.

As illustrated in FIG. 10, the position of the first line L1 at the distal end of the tooth main-body portion 31 in the first direction DIR1 differs in the second direction DIR2 from the position of the first line L1 at the opposite end of the tooth main-body portion 31 from the distal end. Hence, the tooth main-body portion 31 has a quadrangular prism shape. More specifically, in the present embodiment, the first line L1 at the distal end of the tooth main-body portion 31 in the first direction DIR1 is positioned in the opposite direction to the second direction DIR2 relative to the first line L1 at the opposite end of the tooth main-body portion 31 from the distal end of the tooth main-body portion 31 in the first direction DIR1. Hence, in the present embodiment, the tooth main-body portion 31 does not have a plane-symmetric shape with respect to a plane orthogonal to the second direction DIR2.

The magnetic core 1b described above also provides the same advantageous effects as the magnetic core 1. In addition, in the magnetic core 1b, it is possible to reserve a region that overlaps a distal end portion of the tooth main-body portion 31 in the first direction DIR1 when viewed in the second direction DIR2 and that is positioned in the second direction DIR2 or the opposite direction to the second direction DIR2 relative to the distal end portion of the tooth main-body portion 31 in the first direction DIR1. More specifically, the position of the first line L1 at the distal end of the tooth main-body portion 31 in the first direction DIR1 differs in the second direction DIR2 from the position of the first line L1 at the opposite end of the tooth main-body portion 31 from the distal end. In the present embodiment, the first line L1 at the distal end of the tooth main-body portion 31 in the first direction DIR1 is positioned in the opposite direction to the second direction DIR2 relative to the first line L1 at the opposite end of the tooth main-body portion 31 from the distal end of the tooth main-body portion 31 in the first direction DIR1. Hence, in the magnetic core 1b, it is possible to reserve a region that overlaps a distal end portion of the tooth main-body portion 31 in the first direction DIR1 when viewed in the second direction DIR2 and that is positioned in the second direction DIR2 relative to the tooth main-body portion 31 in the first direction DIR1. For example, as illustrated in FIG. 11, this configuration enables a wiring member such as a busbar 40 to be located in a region that overlaps a distal end portion of the tooth main-body portion 31 in the first direction DIR1 when viewed in the second direction DIR2 and that is positioned in the second direction DIR2 relative to the distal end portion of the tooth main-body portion 31 in the first direction DIR1. This shortens the brushless motor 100 in the second direction DIR2, enabling a reduction in its height and size.

### First Modification Example

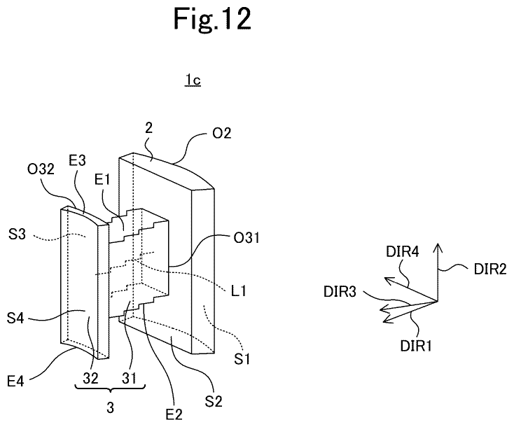

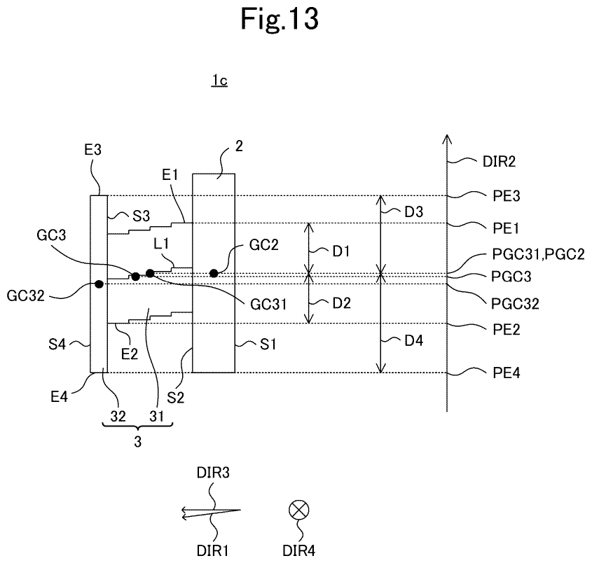

Hereinafter, a magnetic core 1c according to a first modification example of the present disclosure will be described with reference to figures. FIG. 12 is a perspective view of the magnetic core 1c. FIG. 13 is a cross-sectional view of the magnetic core 1c viewed in the fourth direction DIR4. As for the magnetic core 1c according to the first modification example, only the portions different from those of the magnetic core 1b according to the third embodiment will be described, and description of the other portions will be omitted.

As illustrated in FIGS. 12 and 13, the magnetic core 1c differs from the magnetic core 1b in that the first line L1 is a line including a plurality of line segments.

The magnetic core 1c mentioned above also provides the same advantageous effects as the magnetic core 1b.

### Other Embodiments

The magnetic core according to the present disclosure is not limited to the magnetic cores 1 and 1a to 1c and may be changed within the scope of the spirit thereof. The structures of the magnetic cores 1 and 1a to 1c may be combined as appropriate.

Note that the first direction DIR1 may be orthogonal to the second direction DIR2 but is not limited to ones being orthogonal to the second direction DIR2.

Note that the rotating electrical machine needs only to include a structure in which electricity rotates the rotor or a structure in which the rotation of the rotor generates electricity. In this case, the rotating electrical machine needs only to include at least one of the magnetic cores 1 and 1a to 1c and may also include brushes.

The magnetic cores 1 and 1a to 1c may be produced by laminating electromagnetic steel plates. The magnetic cores 1 and 1a to 1c need only to be composed of a soft magnetic material.

Note that the outer surfaces of the magnetic cores 1 and 1a to 1c are not limited to ones subjected to an insulation treatment.

Note that each of the first main surface S1 and the second main surface S2 of the core back portion 2 is not limited to ones having a rectangular shape when viewed in the third direction DIR3.

Note that the core back portion 2 is not limited to ones having a plane-symmetric shape with respect to a plane orthogonal to the second direction DIR2.

Note that the tooth main-body portion 31 is not limited to ones having a rectangular parallelepiped shape or a quadrangular prism shape.

Note that each of the third main surface S3 and the fourth main surface S4 of the tooth distal-end portion 32 is not limited to ones having a rectangular shape when viewed in the third direction DIR3.

Note that the tooth distal-end portion 32 is not limited to ones having a plane-symmetric shape with respect to a plane orthogonal to the second direction DIR2.

Note that the outer edge O2 of the core back portion 2 viewed in the third direction DIR3 is not limited to ones surrounding the outer edge O31 of the tooth main-body portion 31 when viewed in the third direction DIR3. The outer edge O32 of the tooth distal-end portion 32 viewed in the third direction DIR3 is not limited to ones surrounding the outer edge O31 of the tooth main-body portion 31 when viewed in the third direction DIR3.

Note that the length of the tooth main-body portion 31 in the second direction DIR2 when viewed in the fourth direction DIR4 does not necessarily need to be uniform across the third direction DIR3.

Note that in the magnetic core 1, the distance D1 in the second direction DIR2 between the first end El of the tooth main-body portion 31 and the geometric center GC2 of the core back portion 2 may differ from the distance D2 in the second direction DIR2 between the second end E2 of the tooth main-body portion 31 and the geometric center GC2 of the core back portion 2. In the magnetic core 1, the position PGC31 of the geometric center GC31 of the tooth main-body portion 31 in the second direction DIR2 may differ from the position PGC2 of the geometric center GC2 of the core back portion 2 in the second direction DIR2.

Note that in the magnetic core 1a, the distance D3 in the second direction DIR2 between the third end E3 of the tooth distal-end portion 32 and the geometric center GC2 of the core back portion 2 may differ from the distance D4 in the second direction DIR2 between the fourth end E4 of the tooth distal-end portion 32 and the geometric center GC2 of the core back portion 2. In the magnetic core 1a, the position PGC32 of the geometric center GC32 of the tooth distal-end portion 32 in the second direction DIR2 may differ from the position PGC2 of the geometric center GC2 of the core back portion 2 in the second direction DIR2.

Note that the magnetic core 1 is not limited to ones having a plane-symmetric shape with respect to a plane orthogonal to the fourth direction DIR4.

Note that the first line L1 is not limited to only a straight line or a line including a plurality of line segments but may also be a curved line. The first line L1 needs only to include a straight line or a curved line.

Note that in the magnetic core 1b, the first line L1 at the distal end of the tooth main-body portion 31 in the first direction DIR1 may be positioned in the second direction DIR2 relative to the first line L1 at the opposite end of the tooth main-body portion 31 from the distal end of the tooth main-body portion 31 in the first direction DIR1. In this case, it is possible to reserve a region that overlaps a distal end portion of the tooth main-body portion 31 in the first direction DIR1 when viewed in the second direction DIR2 and that is positioned in the opposite direction to the second direction DIR2 relative to the tooth main-body portion 31 in the first direction DIR1.

Note that the brushless motor 100 may be an outer rotor motor. In this case, in the state in which the magnetic core 1 is assembled in the brushless motor 100, the first direction DIR1 is the opposite direction to the direction toward the rotation axis of the brushless motor 100.

Note that the brushless motor 100 is not limited to single-shaft motors. The brushless motor 100 may be, for example, a double-shaft motor.

Note that in the brushless motor 100, the generated thrust force in the direction parallel to the rotation axis may be used to preload each of the first bearing 11a and the second bearing 11b.

Note that each of the first bearing 11a and the second bearing 11b is not limited to ball bearings.

Note that the material of each of the first housing 12a and the second housing 12b needs only to have high stiffness.

The number of magnetic cores 1, the number of coils 13, and the number of insulating members 14 are not limited to nine. Each of the coils 13 and each of the insulating members 14 need only to be located so as to be associated with the corresponding one of the magnetic cores 1.

The present disclosure includes the following configurations.
(1) A magnetic core for a rotating electrical machine, the magnetic core including: a core back portion; and a tooth portion including a tooth main-body portion extending from the core back portion in a first direction and a tooth distal-end portion at a distal end of the tooth main-body portion in the first direction, in which a position of a geometric center of the tooth portion differs from a position of a geometric center of the core back portion in a second direction parallel to a rotation axis of the rotating electrical machine in a state in which the magnetic core is assembled in the rotating electrical machine.
(2) The magnetic core according to (1), in which a position of a geometric center of the tooth main-body portion in the second direction differs from the position of the geometric center of the core back portion in the second direction.
(3) The magnetic core according to (1) or (2), in which a position of a geometric center of the tooth distal-end portion in the second direction differs from the position of the geometric center of the core back portion in the second direction.
(4) The magnetic core according to any one of (1) to (3), in which the tooth main-body portion has a first end and a second end in the second direction, and a distance in the second direction between the first end and the geometric center of the core back portion is smaller than a distance in the second direction between the second end and the geometric center of the core back portion.
(5) The magnetic core according to any one of (1) to (4), in which the tooth distal-end portion has a third end and a fourth end in the second direction, and a distance in the second direction between the third end and the geometric center of the core back portion is smaller than a distance in the second direction between the fourth end and the geometric center of the core back portion.
(6) The magnetic core according to any one of (1) to (5), in which when an orthogonal projection of the first direction onto a plane orthogonal to the second direction is defined as a third direction, and a line connecting the geometric centers of cross sections of the tooth main-body portion perpendicular to the third direction is defined as a first line, the first line is a straight line, and in the second direction, a position of the first line at the distal end of the tooth main-body portion is the same as a position of the first line at an opposite end of the tooth main-body portion from the distal end.
(7) The magnetic core according to any one of (1) to (5), in which when an orthogonal projection of the first direction onto a plane orthogonal to the second direction is defined as a third direction, and a line connecting the geometric centers of cross sections of the tooth main-body portion perpendicular to the third direction is defined as a first line, the first line is a straight line, and in the second direction, a position of the first line at the distal end of the tooth main-body portion differs from a position of the first line at an opposite end of the tooth main-body portion from the distal end.
(8) The magnetic core according to any one of (1) to (5), in which when an orthogonal projection of the first direction onto a plane orthogonal to the second direction is defined as a third direction, and a line connecting the geometric centers of cross sections of the tooth main-body portion perpendicular to the third direction is defined as a first line, the first line is a line including a plurality of line segments, and a position of the first line at the distal end of the tooth main-body portion differs in the second direction from a position of the first line at an opposite end of the tooth main-body portion from the distal end.
(9) The magnetic core according to any one of (1) to (6), in which when an orthogonal projection of the first direction onto a plane orthogonal to the second direction is defined as a third direction, the core back portion has a plane-symmetric shape with respect to a plane orthogonal to the second direction, the tooth main-body portion has a plane-symmetric shape with respect to the plane orthogonal to the second direction, and the tooth distal-end portion has a plane-symmetric shape with respect to the plane orthogonal to the second direction.
(10) The magnetic core according to any one of (1) to (9), in which when an orthogonal projection of the first direction onto a plane orthogonal to the second direction is defined as a third direction, the tooth main-body portion has a uniform length in the second direction across the third direction.
(11) The magnetic core according to any one of (1) to (10), in which each of the core back portion and the tooth portion is a molded body comprising soft magnetic powder.
(12) The magnetic core according to (11), in which a material of the soft magnetic powder comprises iron and resin.
(13) A rotating electrical machine including the magnetic core according to any one of (1) to (12).
(14) A brushless motor including the magnetic core according to any one of (1) to (12).

### Reference Signs List

1, 1a, 1b, 1c, 6 MAGNETIC CORE
2 CORE BACK PORTION
3 TOOTH PORTION
10 STATOR ASSEMBLY
11 BEARING
11a FIRST BEARING
11b SECOND BEARING
12 HOUSING
12a FIRST HOUSING
12b SECOND HOUSING
13 COIL
14 INSULATING MEMBER
20 ROTOR
21 SHAFT
22 ROTOR MEMBER
23 SOFT MAGNETIC MATERIAL
24 HARD MAGNETIC MATERIAL
31 TOOTH MAIN-BODY PORTION
32 TOOTH DISTAL-END PORTION
40 BUSBAR
100 BRUSHLESS MOTOR
D1, D2, D3, D4 DISTANCE
DIR1 FIRST DIRECTION
DIR2 SECOND DIRECTION
DIR3 THIRD DIRECTION
DIR4 FOURTH DIRECTION
E1 FIRST END
E2 SECOND END
E3 THIRD END
E4 FOURTH END
GC1, GC2, GC3, GC6, GC22, GC31, GC32 GEOMETRIC CENTER
L1 FIRST LINE
O2, O31, O32 OUTER EDGE
OP OPENING
S1 FIRST MAIN SURFACE
S2 SECOND MAIN SURFACE
S3 THIRD MAIN SURFACE
S4 FOURTH MAIN SURFACE

1. A magnetic core for a rotating electrical machine, the magnetic core comprising:
a core back portion; and
a tooth portion including a tooth main-body portion extending from the core back portion in a first direction, and a tooth distal-end portion at a distal end of the tooth main-body portion in the first direction, wherein
a position of a geometric center of the tooth portion differs from a position of a geometric center of the core back portion in a second direction parallel to a rotation axis of the rotating electrical machine in a state in which the magnetic core is assembled in the rotating electrical machine.

2. The magnetic core according to claim 1, wherein a position of a geometric center of the tooth main-body portion in the second direction differs from the position of the geometric center of the core back portion in the second direction.

3. The magnetic core according to claim 2, wherein a position of a geometric center of the tooth distal-end portion in the second direction differs from the position of the geometric center of the core back portion in the second direction.

4. The magnetic core according to claim 1, wherein a position of a geometric center of the tooth distal-end portion in the second direction differs from the position of the geometric center of the core back portion in the second direction.

5. The magnetic core according to claim 1, wherein
the tooth main-body portion has a first end and a second end in the second direction, and
a distance in the second direction between the first end and the geometric center of the core back portion is smaller than a distance in the second direction between the second end and the geometric center of the core back portion.

6. The magnetic core according to claim 5, wherein
the tooth distal-end portion has a third end and a fourth end in the second direction, and
a distance in the second direction between the third end and the geometric center of the core back portion is smaller than a distance in the second direction between the fourth end and the geometric center of the core back portion.

7. The magnetic core according to claim 1, wherein
the tooth distal-end portion has a third end and a fourth end in the second direction, and
a distance in the second direction between the third end and the geometric center of the core back portion is smaller than a distance in the second direction between the fourth end and the geometric center of the core back portion.

8. The magnetic core according to claim 1, wherein
when an orthogonal projection of the first direction onto a plane orthogonal to the second direction is defined as a third direction, and
a line connecting the geometric centers of cross sections of the tooth main-body portion perpendicular to the third direction is defined as a first line,
the first line is a straight line, and
in the second direction, a position of the first line at the distal end of the tooth main-body portion is the same as a position of the first line at an opposite end of the tooth main-body portion from the distal end.

9. The magnetic core according to claim 1, wherein
when an orthogonal projection of the first direction onto a plane orthogonal to the second direction is defined as a third direction, and
a line connecting the geometric centers of cross sections of the tooth main-body portion perpendicular to the third direction is defined as a first line,
the first line is a straight line, and
in the second direction, a position of the first line at the distal end of the tooth main-body portion differs from a position of the first line at an opposite end of the tooth main-body portion from the distal end.

10. The magnetic core according to claim 1, wherein
when an orthogonal projection of the first direction onto a plane orthogonal to the second direction is defined as a third direction, and
a line connecting the geometric centers of cross sections of the tooth main-body portion perpendicular to the third direction is defined as a first line,
the first line is a line including a plurality of line segments, and
a position of the first line at the distal end of the tooth main-body portion differs in the second direction from a position of the first line at an opposite end of the tooth main-body portion from the distal end.

11. The magnetic core according to claim 1, wherein
when an orthogonal projection of the first direction onto a plane orthogonal to the second direction is defined as a third direction,
the core back portion has a plane-symmetric shape with respect to a plane orthogonal to the second direction,
the tooth main-body portion has a plane-symmetric shape with respect to the plane orthogonal to the second direction, and
the tooth distal-end portion has a plane-symmetric shape with respect to the plane orthogonal to the second direction.

12. The magnetic core according to claim 1, wherein
when an orthogonal projection of the first direction onto a plane orthogonal to the second direction is defined as a third direction,
the tooth main-body portion has a uniform length in the second direction across the third direction.

13. The magnetic core according to claim 1, wherein each of the core back portion and the tooth portion is a molded body comprising soft magnetic powder.

14. The magnetic core according to claim 13, wherein a material of the soft magnetic powder comprises iron and resin.

15. A rotating electrical machine comprising the magnetic core according to claim 1.

16. A brushless motor comprising the magnetic core according to claim 1.
